(19) United States
(12) Patent Application Publication
(10) Pub. No.: US 2014/0163828 A1
(43) Pub. Date: Jun. 12, 2014

(54) METHOD OF SEARCHNG FOR SYNC START IN AUTOMATED MANUAL TRANSMISSION

(71) Applicants: HYUNDAI MOTOR COMPANY, Seoul (KR); KIA MOTORS CORP, Seoul (KR)

(72) Inventor: Young Min YOON, Seoul (KR)

(73) Assignees: Kia Motors Corp., Seoul (KR); Hyundai Motor Company, Seoul (KR)

(21) Appl. No.: 13/798,651

(22) Filed: Mar. 13, 2013

(30) Foreign Application Priority Data
Dec. 11, 2012 (KR) 10-2012-0143676

(51) Int. Cl. F16D 48/06

(52) U.S. Cl. CPC F16D 48/06
USPC 701/68

(57) ABSTRACT

A method of searching for a sync start in an automated manual transmission includes manual transmission mechanism operated using an actuator. This method can accurately search for a sync start that acts as an important reference for the control in a shift operation so that the sync start can be used for the control of the actuator, which improves shifting response and reduces the chance of a shifting impact occurring, thereby obtaining a high quality of shifting in a reliable fashion.

### CROSS-REFERENCE TO RELATED APPLICATION

The present application claims priority of Korean Patent Application Number 10-2012-0143676 filed Dec. 11, 2012, the entire contents of which application is incorporated herein for all purposes by this reference.

### BACKGROUND OF INVENTION

1. Field of Invention

The present invention relates, in general, to a method of searching for a sync start in an automated manual transmission, and more particularly, to a technology for searching for a sync start, i.e. a point at which actual synchronization starts, when a shifting operation is carried out using an actuator in an automated manual transmission mechanism of the related art, such as a dual clutch transmission (DCT) or an automated manual transmission (AMT).

2. Description of Related Art

In a transmission mechanism using a manual transmission of the related art, when a shifting operation is started following a selecting operation, a sleeve in a neutral position linearly slides in the direction in which a target gear is positioned. At the same time, a key pushes a synchronizer ring so that the synchronizer ring presses a cone of a clutch gear, thereby starting synchronization. When the synchronization is completed, the sleeve meshes with the clutch gear through the synchronizer ring, thereby completing shifting to the target gear.

In an automated manual transmission, the above-described shifting operation is carried out by a shifting actuator. In order to satisfy conflicting requirements including rapid shifting response and smooth shifting sensation, the shifting operation using the shifting actuator is controlled such that the sleeve is moved as rapidly as possible before the sync start where the synchronizer ring starts adjoining the cone of the clutch gear, and afterwards, is moved slowly using as smooth a movement as possible until the synchronization is completed.

If the sync start is erroneously estimated, for example, if, in controlling the shifting actuator, the sync start is estimated to be a point that is too close to the neutral position, the sleeve must also be moved to the sync start, which increases a shifting time, thereby degrading the response. In contrast, if the sync start is estimated to be a point that is too far, a shifting impact occurs.

An exemplar of the prior art is Korean Patent Laid-open Publication No. 10-2012-0038797.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art, and the present invention is intended to propose a method of searching for a sync start in an automated manual transmission in which a manual transmission mechanism is operated using an actuator. This method can accurately search for a sync start that acts as an important reference for the control in a shift operation so that the sync start can be used for the control of the actuator, which improves shifting response and reduces the chance of a shifting impact occurring, thereby obtaining a high quality of shifting in a reliable fashion.

Various aspects of the present invention provide for a method of searching for a sync start in an automated manual transmission. The method includes the following steps of: measuring vibrations while engaging gear shafts with each other for a predetermined gear; and inverse-estimating sync starts by deducting a predetermined deduction distance from a point where a sharp increase in vibrations has been measured during the process of measuring vibrations. The deduction distance is a preset value from the sync start to a time point where the sleeve adjoins a clutch gear.

According to the present invention, in the method of searching for a sync start in the automated manual transmission in which the manual transmission mechanism is operated using the actuator, the sync start that acts as an important reference for the control in a shift operation can be accurately searched for so that the sync start can be used for the control of the actuator, which improves shifting response and reduces the change of a shifting impact occurring, thereby obtaining a high quality of shifting in a reliable fashion.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a sequence diagram showing an exemplary method of searching for a sync start in an automated manual transmission according to the present invention.

FIG. 2 is a graph showing an exemplary method of searching for a sync start in an automated manual transmission according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

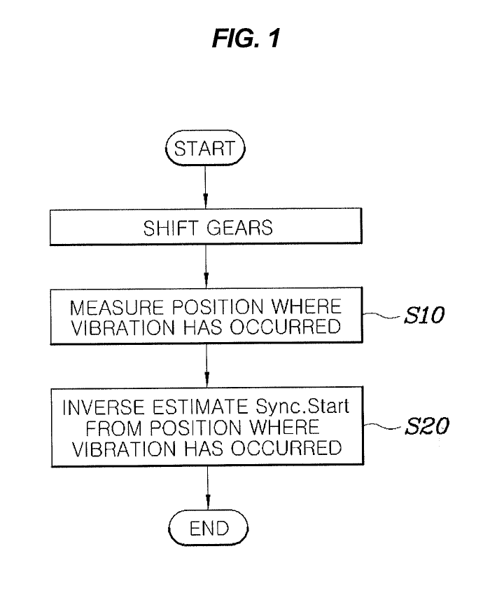

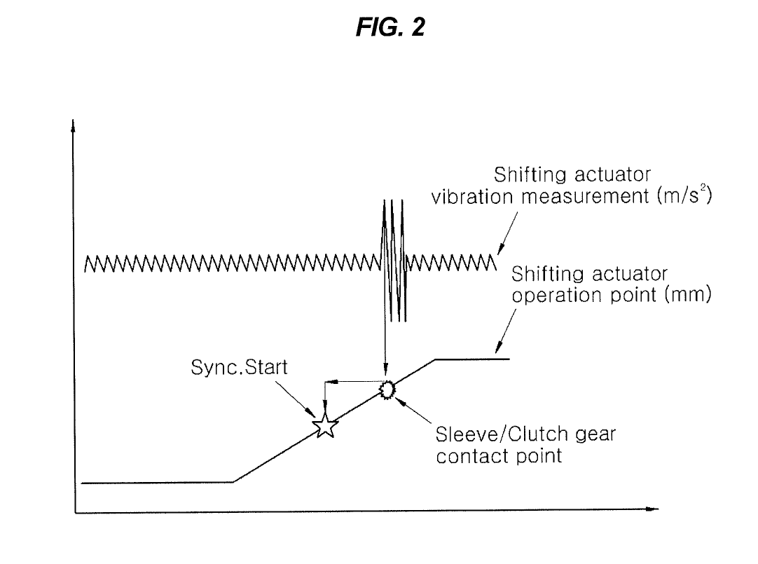

Referring to FIG. 1 and FIG. 2, a method of searching for a sync start in an automated manual transmission according to various embodiments of the invention includes a vibration measurement step S10 of measuring vibrations while engaging gear shafts with each other for a predetermined gear and an inverse estimation step S20 of estimating a sync start by deducting a predetermined deduction distance from a point where an extreme increase in vibrations is measured at the vibration measurement step S10.

The deduction distance at the inverse estimation step S20 is a preset value of a distance from the sync start to a time point where a sleeve adjoins a clutch gear.

This is conceived from the fact that a sharp increase in vibrations occurs at a time point when the sleeve and the clutch gear start adjoining each other while gears are being shifted in the automated manual transmission.

Specifically, in the process of completing gear shifting by moving the sleeve from a neutral mode into the predetermined gear, a vibration that occurs in the range in which the sleeve starts adjoining and meshing with the clutch gear exhibits a sharper increase than in any other ranges in which the sleeve moves. Based on this characteristic, the time point where the sharp increase in vibrations is detected using a vibration sensor or the like, and the deduction distance, that is, the preset value, is deduced from the time point where the vibration has occurred. The resultant point corresponds to the sync start of the predetermined gear.

Here, the vibration measurement step S10 measures vibrations of a shifting actuator which engages the gear shafts with each other, and the inverse estimation step S20 deducts the deduction distance from a point where a sharp increase in vibrations of the shifting actuator has occurred.

Of course, it is also possible to carry out the inverse estimation step S20 by mounting a vibration sensor on a transmission housing and detecting vibrations that are detected from the transmission housing.

The vibration measurement step S10 and the inverse estimation step S20 are respectively carried out for individual gears of the transmission. At the inverse estimation step S20, sync starts for the individual gears are estimated by respectively deducting detection distances that are separately memorized for the individual gears.

In this fashion, the sync starts for the individual gears are obtained by carrying out the vibration measurement step S10 and the inverse estimation step S20 for the individual gears which can be realized by the transmission. When the sync starts that have been separately obtained for the individual gears are used in the later event of shifting gears, improved shifting quality can be realized.

In various embodiments, it may be preferred that vibration measurement step S10 and the inverse estimation step S20 be carried out in a factory where the transmission is assembled. In addition, in various embodiments, it may be preferred that the sync starts that have been estimated at the inverse estimation step S20 be stored in a memory in a controller of the transmission or in a separate storage device which the controller can access.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A method of searching for a sync start in an automated manual transmission, the method comprising:
measuring vibration while engaging gear shafts with each other for a predetermined gear; and
inverse-estimating sync starts by deducting a predetermined deduction distance from a point where a sharp increase in vibration has been measured during the process of measuring vibration;
wherein the deduction distance is a preset value from the sync start to a time point where the sleeve adjoins a clutch gear.

2. The method of claim 1, wherein
the process of measuring vibration comprises measuring vibration of a shifting actuator which engages the gear shafts with each other, and
the process of inverse-estimating the sync start comprises deducting the deduction distance from a point where a sharp increase in vibration of the shifting actuator has occurred.

3. The method of claim 1, wherein
the process of measuring vibration and the process of inverse-estimating the sync start are respectively carried out for individual gears of the transmission, and
the process of inverse-estimating the sync start comprises respectively estimating sync starts for the individual gears by deducting deduction distances that are separately stored in memory for the individual gears.

4. The method of claim 1, wherein
the process of measuring vibration and the process of inverse-estimating the sync start are carried out in a factory where the transmission is assembled, and
the sync starts that have been estimated at the process of inverse-estimating the sync start are stored in memory in a controller of the transmission.
